(19) United States
(12) Patent Application Publication
(10) Pub. No.: US 2012/0196207 A1
(43) Pub. Date: Aug. 2, 2012

(54) ELECTRODE CATALYST FOR FUEL CELL, METHOD OF PREPARING THE SAME, MEMBRANE ELECTRODE ASSEMBLY AND FUEL CELL INCLUDING THE SAME

(75) Inventors: Dae-jong YOO, Seoul (KR); Chan-ho PAK, Seoul (KR); Kang-hee LEE, Suwon-si (KR)

(73) Assignee: Samsung Electronics Co., Ltd., Suwon-Si (KR)

(21) Appl. No.: 13/205,940

(22) Filed: Aug. 9, 2011

(30) Foreign Application Priority Data
Feb. 1, 2011 (KR) 10-2011-0010298

(51) Int. Cl. H01M 4/92; B01J 23/652; B01J 21/06; B01J 23/656; B01J 23/89; H01M 4/88; B01J 23/648; B01J 23/50; B01J 23/52; B01J 23/46; B01J 21/18; B01J 23/44; B01J 23/60

(52) U.S. Cl. 429/487; 502/339; 502/313; 502/324; 502/326; 502/329; 502/331; 502/330; 502/185

(57) ABSTRACT

An electrode catalyst for a fuel cell, a method of preparing the same, and a membrane electrode assembly and a fuel cell including the same. The electrode catalyst includes a catalyst particle that incorporates a plurality of palladium atoms, a plurality of atoms of a transition metal, and a plurality of atoms of a precious metal having a higher standard reduction potential than the transition metal, where all of the plurality of atoms of the transition metal are respectively surrounded by at least one of the palladium atoms, the neighboring atoms of the transition metal, or the atoms of the precious metal.

### CROSS-REFERENCE TO RELATED APPLICATIONS

This application claims the benefit of Korean Patent Application No. 10-2011-0010298, filed on Feb. 1, 2011 in the Korean Intellectual Property Office, the disclosure of which is incorporated herein in its entirety by reference.

### BACKGROUND

1. Field

Aspects of the present disclosure relate to an electrode catalyst for a fuel cell, a method of preparing the same, and a membrane electrode assembly and a fuel cell including the same.

2. Description of the Related Art

Fuel cells may be classified into polymer electrolyte membrane fuel cells (PEMFC), direct methanol fuel cells (DMFC), phosphoric acid fuel cells (PAFC), molten carbonate fuel cells (MCFC), and solid oxide fuel cells (SOFC), according to the types of electrolyte and fuel used in the fuel cells.

The PEMFC and the DMFC cells generally have a membrane electrode assembly (MEA) including an anode, a cathode, and a polymer electrolyte membrane disposed between the anode and the cathode. The anode includes a catalyst layer for accelerating oxidation of a fuel, and the cathode includes a catalyst layer for accelerating reduction of an oxidizing agent.

Generally, a catalyst using platinum (Pt) as an active material is mainly used as a component of the anode and the cathode, but Pt is an expensive precious metal, and the amount of Pt required to be used in an electrode catalyst is high when mass-producing commercial fuel cells. Thus, it is a priority to reduce expenses of manufacturing of fuel cells.

Accordingly, studies have been ongoing to develop an electrode catalyst to replace a Pt-based catalyst, and to develop a fuel cell having high cell performance by using such an electrode catalyst.

### SUMMARY

Aspects of the present invention provide an electrode catalyst for a fuel cell and a method of preparing the same, wherein excellent catalyst activity and catalyst stability are simultaneously provided.

Aspects of the present invention provide a membrane electrode assembly and a fuel cell that includes the electrode catalyst.

According to an aspect of the present invention, an electrode catalyst for a fuel cell, the electrode catalyst includes a catalyst particle that incorporates a plurality of palladium atoms, a plurality of atoms of a transition metal, and a plurality of atoms of a precious metal having a higher standard reduction potential than the transition metal, wherein all of the plurality of atoms of the transition metal are respectively surrounded by at least one of the palladium atoms, the neighboring atoms of the transition metal, or the atoms of the precious metal.

The transition metal may be at least one metal from among titanium (Ti) vanadium (V), chromium (Cr), manganese (Mn), iron (Fe), cobalt (Co), nickel (Ni), copper (Cu), and zinc (Zn).

The precious metal may be at least one metal from among iridium (Ir), gold (Au), platinum (Pt), rhodium (Rh), and silver (Ag).

The catalyst particle may have a surface that comprises palladium atoms or atoms of the precious metal.

The catalyst particle may have an outermost atomic layer that comprises palladium atoms or atoms of the precious metal.

The electrode catalyst may further include a carbon-based support.

Another aspect of the present invention provides a method of preparing an electrode catalyst for a fuel cell, the method including: preparing a first catalyst from a first catalyst particle that includes a plurality of palladium atoms and a plurality of atoms of a transition metal, wherein at least some of the plurality of atoms of the transition metal exists on the surface of the first catalyst particle; and converting the first catalyst to the electrode catalyst by contacting the first catalyst with a precious metal precursor having a higher standard reduction potential than the transition metal.

The first catalyst may further include a carbon-based support.

The first catalyst particle may further include an atom of a precious metal having a higher standard reduction potential than the transition metal.

In the conversion of the first catalyst, the atoms of the transition metal existing on the surface of the first catalyst particle may be substituted by atoms of the precious metal of the precious metal precursor.

The conversion of the first catalyst may be performed by: preparing a second mixture including the first catalyst and the precious metal precursor; and heat-treating the second mixture. The second mixture may further include at least one of a glycol-based solvent and an alcohol-based solvent. The second mixture may be heat-treated at a temperature from about 80 to about 400° C. for a time period from about 1 hour to about 4 hours.

The amount of precious metal in the precious metal precursor may be in a range from about 0.5 parts by weight to about 20 parts by weight based on 100 parts by weight of the first catalyst.

Another aspect of the present invention provides a membrane electrode assembly for a fuel cell, the membrane electrode assembly including: a cathode; an anode disposed facing the cathode; and an electrolyte membrane disposed between the cathode and the anode, wherein at least one of the cathode and the anode includes the electrode catalyst described above.

Another aspect of the present invention provides a fuel cell including the membrane electrode assembly described above.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 illustrates schematic cross-sectional diagrams respectively of a first catalyst particle according to an embodiment of the present invention, and a catalyst particle according to an embodiment of the present invention;

FIG. 2 is an exploded perspective view of a fuel cell according to another embodiment of the present invention;

FIG. 3 is a schematic cross-sectional view of a membrane electrode assembly (MEA) included in the fuel cell of FIG. 2;

FIG. 4 is a graph showing X-ray diffraction patterns of catalysts prepared according to Comparative Examples A through C, and Examples 1 and 2;

FIG. 5 is a graph showing electric characteristics of unit cells respectively employing the catalysts of Comparative Examples A through C, and Examples 1 and 2; and

FIG. 6 is a graph describing the stability of the unit cell employing the catalyst of Example 2.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electrode catalyst for a fuel cell includes a catalyst particle incorporating a plurality of palladium atoms, a plurality of atoms of a transition metal, and a plurality of atoms of a precious metal having a higher standard reduction potential than the transition metal. All atoms of the transition metal in the catalyst particle are respectively surrounded by at least one of the palladium atom, a neighboring atom of the transition metal, or an atom of the precious metal. In other words, the atom of the transition metal included in the catalyst particle exists inside the catalyst particle, instead of being exposed outside the catalyst particle by being disposed on a surface of the catalyst particle.

Palladium is the principal catalyst metal that can be used for an electrode catalyst for a fuel cell, has excellent catalyst activity, and may replace platinum.

The electron density of palladium may be changed by alloying palladium with the transition metal. Accordingly, an adsorption bond of palladium with oxygen is decreased, and thus catalyst activity may be increased. The transition metal may be at least one metal from among titanium (Ti), vanadium (V), chromium (Cr), manganese (Mn), iron (Fe), cobalt (Co), nickel (Ni), copper (Cu), and zinc (Zn), but is not limited thereto.

Meanwhile, the precious metal that is alloyed with the principal palladium catalyst, could provide the high stability to its catalyst. The precious metal may be at least one metal from among iridium (Ir), gold (Au), platinum (Pt), rhodium (Rh), and silver (Ag), but is not limited thereto.

Here, a part of the transition metal in the first catalyst particle including the palladium and the transition metal, or the palladium, the transition metal, and the precious metal may be exposed outside the first catalyst particle by being separated from the first catalyst particle and disposed on the surface of the first catalyst particle. However, since an aqueous solution included in a membrane electrode assembly (MEA) of a fuel cell, in which hydrogen ions may be transmitted through water, may be acidic, the transition metal on the surface of the first catalyst particle may be dissolved in such an acidic aqueous solution in the MEA. As a result, catalyst activity and stability of the first catalyst particle may deteriorate.

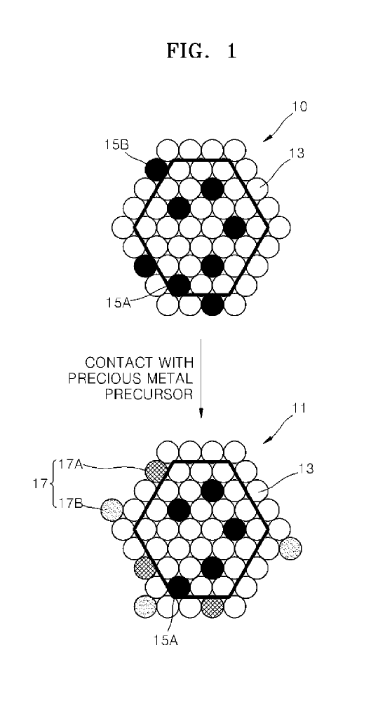

FIG. 1 illustrates a schematic cross-section of a first catalyst particle 10 according to an embodiment of the present invention. The first catalyst particle 10 includes a plurality of palladium atoms 13 and a plurality of atoms 15A and 15B of a transition metal. Here, inside and outside an illustrated virtual line in the cross-section of the first catalyst particle 10 respectively denote the inside and surface of the first catalyst particle 10. The atoms 15A of the transition metal exist inside the first catalyst particle 10, and the atoms 15B of the transition metal exist on the surface of the first catalyst particle 10.

A “first catalyst particle 10” used herein denotes a particle, wherein an atom of a transition metal exists on a surface of the particle, unlike the catalyst particle 11 (described below).

Also, “a (the) surface of a (the) first catalyst particle 10” and “a (the) surface of a (the) catalyst particle” used herein may denote the outermost atomic layer of the first catalyst particle 10 and the catalyst particle 11. Here, the thickness of the outermost atomic layer may be from about 1 to about 20 times, for example, from about 1 to about 10 times, for example, from about 1 to about 5 times, of the maximum diameter from among the diameters of atoms constituting the outermost atomic layer.

According to an embodiment, the thickness of the outmost atomic layer may be one time, i.e., equal to, the maximum diameter from among the diameters of the atoms constituting the outermost atomic layer, as shown in FIG. 1. In other words, the outermost atomic layer may be a single layer of atoms existing on the surface of the first catalyst particle 10 and catalyst particle 11, as shown in FIG. 1. The terms “surface” and “outermost atomic layer” are easily understood with reference to FIG. 1, and are defined at an atomic level, and thus are clearly different from a shell (for example, generally a thin film) in a typical core-shell structure.

“Inside a (the) first catalyst particle 10” used herein denotes an area excluding the surface of the first catalyst particle 10, and “inside a (the) catalyst particle 11” used herein denotes an area excluding the surface of the catalyst particle 11.

In FIG. 1, the atom 15A of the transition metal existing inside the first catalyst particle 10 may alloy with the palladium to improve catalyst activity, but the atom 15B of the transition metal existing on the surface of the first catalyst particle 10 may cause deterioration of the catalyst stability for the above-described reasons.

However, unlike the first catalyst particle 10, “all” atoms of the transition metal in the catalyst particle are respectively surrounded by at least one of a palladium atom, a neighboring atom of the transition metal, or an atom of the precious metal. In other words, “all” atoms of the transition metal included in the catalyst particle 11 exist inside the catalyst particle 11, instead of on the surface of the catalyst particle 11. Accordingly, the catalyst particle 11 may have excellent catalyst activity without deteriorating catalyst stability.

According to an embodiment of the present invention, the catalyst particle 11 may have a surface that does not include an atom of the transition metal. The “surface” may be defined as above.

According to another embodiment of the present invention, the catalyst particle 11 may have an outermost atomic layer that does not include the atom of the transition metal. The “outermost atomic layer” has already been described in detail above.

FIG. 1 also illustrates a schematic cross-section of a catalyst particle 11 according to an embodiment of the present invention. The catalyst particle 11 includes a plurality of palladium atoms 13, a plurality of atoms 17 of a precious metal, and a plurality of atoms 15A of a transition metal.

Inside and outside of an illustrated virtual line in the cross-section of the catalyst particle 11 respectively denote the inside and a surface of the catalyst particle 11. All atoms 15A of the transition metal included in the catalyst particle 11 are surrounded by palladium atoms 13. In other words, all atoms 15A of the transition metal exist only in the catalyst particle 11. In detail, the palladium atoms 13 and the atoms 17 of the precious metal exist on the surface of the catalyst particle 11, but the atoms 15A of the transition metal do not exist on the surface of the catalyst particle 11. Accordingly, the catalyst particle 11 has a surface that does not include the atoms 15A of the transition metal. Meanwhile, since the surface of the catalyst particle 11 has the form of an atomic layer in a single layer of atoms, the catalyst particle 11 has an outermost atomic layer that does not include the atoms 15A of the transition metal. Accordingly, the catalyst particle 11 may have excellent catalyst activity without deterioration of catalyst stability.

In FIG. 1, the atoms 17 of the precious metal include an atom 17A of the precious metal substituted for the atom 15B of the transition metal, and an atom 17B of the precious metal adhered to the surface of the catalyst particle 11. The atoms 17A and 17B of the precious metal will be described in detail later.

Amounts of the palladium 13, the transition metal 15A and 15B, and the precious metal 17 in the catalyst particle 11 of the electrode catalyst may be selected from well-known ranges.

Aside from the catalyst particle 11 described above, the electrode catalyst may further include a carbon-based support. When the electrode catalyst further includes the carbon-based support, the catalyst particle 11 may be loaded in the carbon-based support.

The carbon-based support may be selected from among electric conductive materials. For example, the carbon-based support may be at least one of ketjen black, carbon black, graphite carbon, carbon nanotube, and carbon fiber, but is not limited thereto.

When the electrode catalyst further includes the carbon-based support, the amount of the catalyst particle 11 may be from about 30 to about 70 parts by weight, for example, from about 40 to about 60 parts by weight based on 100 parts by weight of the electrode catalyst including the carbon-based support. When the ratio of the catalyst particle to the carbon-based support is within the above range, the specific surface area and the loaded amount of the catalyst particle 11 may be high.

A method of preparing the electrode catalyst for a fuel cell will now be described in detail. First, a first catalyst is prepared including a first catalyst particle 10 incorporating a plurality of palladium atoms and a plurality of atoms of a transition metal, wherein at least some of the atoms of the transition metal exist on the surface of the first catalyst particle 10.

The first catalyst particle 10 has already been described in detail above. The “first catalyst” used herein denotes a catalyst including the first catalyst particle 10, and according to the method, the “first catalyst” including the “first catalyst particle 10” is converted to the “electrode catalyst” for a fuel cell including the “catalyst particle 11”.

The first catalyst may be prepared by using any well known method. For example, the first catalyst may be prepared by providing a first mixture including a palladium precursor and a transition metal precursor, and preparing the first catalyst including the first catalyst particle 10 by reducing the palladium and transition metal precursors in the first mixture.

The palladium precursor may be at least one of a chloride, a nitride, cyanide, a sulfide, a bromide, a nitrate, an acetate, a sulfate, an oxide, and an alkoxide, which include palladium. For example, the palladium precursor may be at least one of palladium nitride, palladium chloride, palladium sulfide, palladium acetate, palladium acetylacetonate, palladium cyanide, palladium isopropoxide, and palladium butoxide, but is not limited thereto. For example, the palladium precursor may be a palladium chloride, such as potassium tetrachloropalladate, K₂PdCl₄.

The transition metal precursor may be at least one of a chloride, a nitride, a cyanide, a sulfide, a bromide, a nitrate, an acetate, a sulfate, an oxide, and an alkoxide, which include the transition metal described above. For example, the transition metal precursor may be at least one of nitrides, chlorides, sulfide, salts (for example, copper acetate, iron acetate, cobalt acetate, nickel acetate, copper acetylacetonate, iron acetylacetonate, cobalt acetylacetonate, and nickel acetylacetonate), cyanides, oxides (for example, copper isopropoxide, iron isopropoxide, cobalt isopropoxide, and nickel isopropoxide), and alkoxides (for example, copper butoxide, iron butoxide, cobalt butoxide, and nickel butoxide) of Ti, V, Cr, Mn, Fe, Co, Ni, Cu, and Zn, but is not limited thereto. For example, when the transition metal is Cu, the transition metal precursor may be a Cu chloride, such as CuCl₂.2H₂O.

The first mixture may further include, aside from the palladium and transition metal precursors, a carbon-based support. When the first mixture further includes the carbon-based support, the first catalyst including the carbon-based support and the first catalyst particle 10 loaded in the carbon-based support may be obtained.

The first mixture may further include, aside from the palladium and transition metal precursors, a solvent for dissolving the palladium and transition metal precursors. The solvent may be a glycol-based solvent, such as ethylene glycol, 1,2-propylene glycol, 1,3-butanediol, 1,4-butanediol, neopentyl glycol, diethylene glycol, 3-methyl-1,5-pentanediol, 1,6-hexanediol, or trimethylol propane, or an alcohol-based solvent, such as methanol, ethanol, isopropyl alcohol (IPA), or butanol. However, the solvent is not limited thereto, and may be any well known solvent capable of dissolving the palladium and transition metal precursors.

The amount of the solvent may be from about 15,000 to 100,000 parts by weight based on 100 parts by weight of the palladium precursor. When the amount of the solvent is within the above range, a uniform metal alloy may be formed when the palladium and transition metal precursors in the first mixture are reduced. When the first mixture further includes the carbon-based support, dispersibility of the first catalyst particle in the carbon-based support may be improved.

The first mixture may further include a precious metal precursor having a higher standard reduction potential than the transition metal. The precious metal precursor included in the first mixture and a precious metal precursor included in a second mixture, which will be described later, may be identical to or different from each other.

When the first mixture further includes the precious metal precursor, the first catalyst particle 10 may include an atom of a precious metal having a higher reduction potential than the transition metal. The location of the atom of the precious metal in the first catalyst particle 10 is not limited. For example, the atom of the precious metal may exist both inside and on the surface of the first catalyst particle 10.

The first mixture may further include a chelating agent, such as ethylene diamine tetraacetatic acid (EDTA), and a pH adjuster, such as an NaOH aqueous solution, etc. The chelating agent enables the palladium precursor, the transition metal precursor, and optionally, the precious metal precursor, to be simultaneously reduced.

Next, the palladium precursor, the transition metal precursor, and optionally, the precious metal precursor in the first mixture, are reduced to provide the first catalyst including the first catalyst particle 10. Here, if the first mixture includes the carbon-based support, the first catalyst may be loaded on the carbon-based support.

The first catalyst may be prepared by adding a reducing agent to the first mixture. The reducing agent may be selected from a material capable of reducing the palladium precursor, the transition metal precursor, and optionally, the precious metal precursor in the first mixture. Examples of the reducing agent include hydrazine (NH₂NH₂), sodium borohydride (NaBH₄), and formic acid, but are not limited thereto. The amount of the reducing agent may be from about 1 to about 3 mol based on 1 mol of the palladium precursor, and when the amount of the reducing agent is within the above range, a satisfactory reduction reaction may be induced.

The reduction reaction of the palladium, transition metal, and optionally precious metal precursors in the first mixture may be different according to type and amount of the precursor, and may be performed at a temperature from about 30° C. to about 80° C., for example, from about 50° C. to about 70° C.

According to the method, since a first catalyst is obtained by reducing a metal precursor in a solvent metal atoms in the first catalyst particle 10 are randomly arranged. Accordingly, for example, the atoms of the transition metal may exist both inside (15A) and on the surface (15B) of the first catalyst particle 10 as in FIG. 1.

Then, the first catalyst is contacted with the precious metal precursor so as to substitute the atoms of the transition metal on the surface of the first catalyst particle 10 by the atom of the precious metal 17, thereby converting the first catalyst to the electrode catalyst for the fuel cell. Since the precious metal 17 has a higher standard reduction potential than the transition metal 15B, the atom of the transition metal 15B on the surface of the first catalyst particle 10 may be easily substituted with the atom of the precious metal 17. As such, the electrode catalyst including the catalyst particle 11 as described above may be obtained.

In detail, referring to FIG. 1, the atom 15B of the transition metal on the surface of the first catalyst particle 10 is substituted by the atom 17A of the precious metal as the first catalyst particle 10 contacts the precious metal precursor, and thus the electrode catalyst including the catalyst particle 11 may be obtained. When an excessive amount of precious metal precursor is used, beyond that required to substitute for the atom 15B of the transition metal on the surface of the first catalyst particle 10, the precious metal precursor is reduced on the surface of the catalyst particle 11, and thus the atom 17B of the precious metal may also exist on the surface of the catalyst particle 11.

Conversion of the first catalyst to the electrode catalyst will now be described in detail. First, a second mixture including the first catalyst and the precious metal precursor is provided. The precious metal precursor may be at least one of a chloride, a nitride, a cyanide, a sulfide, a bromide, a nitrate, an acetate, a sulfate, an oxide, and an alkoxide, which include the precious metal described above.

For example, the precious metal precursor may be at least one of nitrides, chlorides, sulfides, salts (for example, iridium acetate, gold acetate, platinum acetate, iridium acetylacetonate, gold acetylacetonate, and platinum acetylacetonate), cyanides, oxides (for example, iridium isopropoxide, gold isopropoxide, and platinum isopropoxide), and alkoxides (for example, iridium butoxide, gold butoxide, and platinum butoxide) of Ir, Au, Pt, Rh, and Ag, but is not limited thereto. For example when the precious metal is Ir, the precious metal precursor may be an Ir chloride, such as H₂IrCl₆.6H₂O.

The amount of the precious metal 17 in the precious metal precursor in the second mixture may be in the range from about 0.5 to about 20 parts by weight, for example, from about 0.8 to about 15 parts by weight based on 100 parts by weight of the first catalyst. When the amount of the precious metal 17 is within the above range, both catalyst activity and catalyst stability of the electrode catalyst that is described later are simultaneously increased.

The second mixture may further include a solvent, a chelating agent, and a pH adjuster. The solvent, the chelating agent, and the pH adjuster have already been described in detail above with reference to the first mixture.

For example, the second mixture may include a glycol-based solvent, such as ethylene glycol, 1,2-propylene glycol, 1,3-butanediol, 1,4-butanediol, neopentyl glycol, diethylene glycol, 3-methyl-1,5-pentanediol, 1,6-hexanediol, or trimethylol propane, and/or an alcohol-based solvent, such as methanol, ethanol, IPA, or butanol. A hydroxyl group of the glycol-based solvent and/or the alcohol-based solvent dissolves a metal precursor in the second mixture, thereby reducing the metal precursor to a metal during, for example, heating (a polyol process).

Next, the second mixture is heat-treated so as to convert the first catalyst to the electrode catalyst. Conditions for the heat-treating of the second mixture may be selected within a range in which the atom of the transition metal 15B on the surface of the first catalyst particle 10 is substituted with the atom of the precious metal 17A of the precious metal precursor in the second mixture. Such conditions may differ according to the type and amount of precursor used, and for example, the heat-treating may be performed at a temperature from about 80 to about 400° C. for a time period from about 1 to about 4 hours.

The method of preparing the first catalyst may be identical to the method of preparing a typical electrode catalyst for a fuel cell. Since the method of preparing the first catalyst includes alloying a metal by reducing a precursor in a solvent, the arrangement of atoms of the metal in a first catalyst particle 10 is difficult to control. Accordingly, the atom of the transition metal 15A or 15B in the first catalyst particle 10 randomly exists both inside and on the surface of the first catalyst particle 10 (refer to FIG. 1), and as a result, the first catalyst may have low catalyst stability due to the exposure of the atom (refer to 15B of FIG. 1) of the transition metal on the surface of the first catalyst particle 10.

Accordingly, as described above, the first catalyst was prepared first, and only the atom of the transition metal on the surface of the first catalyst particle was substituted by the atom of the precious metal, thereby maintaining the amount of the atoms (refer to 15A of FIG. 1) of the transition metal in the catalyst particle 11 while removing the atom of the transition metal on the surface of the catalyst particle 11 (the atom 15B of the transition metal on the surface of the first catalyst particle 10 in FIG. 1 is substituted with the atom 17A of the precious metal). Accordingly, the electrode catalyst, wherein catalyst activity is improved by the atom of the transition metal 15A in the catalyst particle 11 and the possibility of catalyst stability from deterioration due to the atom of the transition metal on the surface of the catalyst particle 15B is removed. Accordingly, the electrode catalyst “simultaneously” has excellent catalyst activity and catalyst stability. Furthermore, distribution of the atoms of the transition metal 15A in the catalyst particle 11 of the electrode catalyst, i.e., distribution of the atoms of the transition metal 15A inside the catalyst particle 11, but not on the surface of the catalyst particle 11, may be controlled based on a simple wet process based on a method of reducing a precursor in a solvent.

Since the electrode catalyst is obtained by converting the first catalyst by substituting “only” the atom of the transition metal 15B on the surface of the first catalyst particle with the atom of the precious metal, inductively coupled plasma (ICP) analysis data and an X-ray diffraction (XRD) pattern of the first catalyst and the electrode catalyst may have the following relationships.

When X₁ and Y₁ respectively denote amounts of a transition metal and a precious metal in ICP measurements of the first catalyst in an amount of “A” g, and X₂ and Y₂ respectively denote amounts of a transition metal and a precious metal of ICP measurements of the electrode catalyst in an amount of “A+B” g, X₁>X₂ and Yᵢ<Y₂. Here, “A” denotes the weight of the first catalyst, “B” denotes the amount of precious metal in the precious metal precursor, “A+B” denotes the weight of the electrode catalyst, the unit of the weights and amounts is g, and the conditions for the ICP analysis is a radio frequency (RF) source of 27.12 MHz and a sample uptake rate of 0.8 ml/min.

If the atoms of the transition metal 15B of the first catalyst particle 10 are not substituted by the atoms of the precious metal 17A, but the atoms of the precious metal 17B were simply “added” to the first catalyst particle, X₁ may have been approximately equal to X₂.

Meanwhile, the difference between a diffraction angle (2theta) of a (111) peak of an XRD pattern of the first catalyst measured by Ka1 of Cu, and a diffraction angle (2theta) of a (111) peak of a diffracted XRD pattern of the electrode catalyst measured by Ka1 of Cu is below or equal to 0.1, for example, below or equal to 0.03. In other words, the lattice structure of the first catalyst particle 10 of the first catalyst and the lattice structure of the catalyst particle 11 of the electrode catalyst are substantially identical.

For example, when the atom of the transition metal 15B of the first catalyst particle 10 is substituted by the atom of the precious metal 17A, wherein even the atom of the transition metal 15A inside of the first catalyst particle 10 is substituted by the atom of the precious metal, since the diameter of the atom of the precious metal is relatively large compared to diameters of the palladium atom and the atom of the transition metal 15A, the lattice structure in the partial region of the catalyst particle 11 may be different from the lattice structure in the partial region of the first catalyst particle 10, and thus the difference between the diffraction angles may increase, for example, the difference may be above 0.1. The ICP and XRD pattern analyses as described above will be described in more detail later with reference to Evaluation Example 1.

An MEA for a fuel cell, according to an embodiment of the present invention includes a cathode and an anode, which face each other, and an electrolyte membrane disposed between the cathode and the anode, wherein the cathode includes the electrode catalyst described above.

A fuel cell according to an embodiment of the present invention includes an MEA. A separator may be disposed on each side of the MEA. The MEA includes a cathode, an anode, and an electrolyte membrane disposed between the cathode and the anode, wherein at least one of the cathode and the anode includes the electrode catalyst described above. The fuel cell may be a polymer electrolyte membrane fuel cell (PEMFC), a phosphoric acid fuel cell (PAFC), or a molten carbonate fuel cell (MCFC).

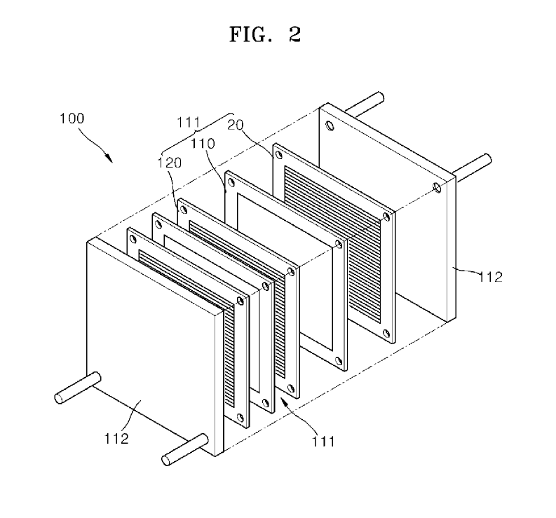

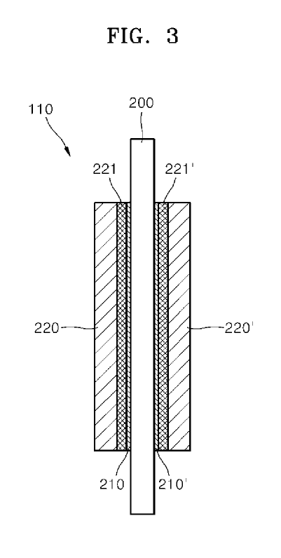

FIG. 2 is an exploded perspective view of a fuel cell 100 according to an embodiment of the present invention, and FIG. 3 is a schematic cross-sectional view of an MEA 110 included in the fuel cell 100 of FIG. 2. The fuel cell 100 of FIG. 2 includes a pair of holders 112 and two unit cells 111 disposed between the holders 112. The unit cell 111 includes the MEA 110, and bipolar plates 120 disposed on each side of the MEA 110 in the thickness direction. The bipolar plate 120 is formed of a conductive metal or carbon, and is directly adhered to the MEA 110, and thus operates as a current collector while supplying oxygen and fuel to a catalyst layer of the MEA 110. Meanwhile, there are two unit cells 111 in the fuel cell 100 of FIG. 2, but the number of unit cells 111 is not limited thereto, and may be dozens to hundreds according to characteristics required in the fuel cell 100.

As shown in FIG. 3, the MEA 110 may include an electrolyte membrane 200, catalyst layers 210 and 210′ respectively disposed on sides of the electrolyte membrane 200 in the thickness direction, wherein an electrode catalyst according to an embodiment of the present invention is employed by one of the catalyst layers 210 and 210′, first gas diffusion layers 221 and 221′ respectively stacked on sides of the catalyst layers 210 and 210′, and second gas diffusion layers 220 and 220′ respectively stacked on sides of the first gas diffusion layers 221 and 221′.

The catalyst layers 210 and 210′ operate as a fuel pole and an oxygen pole, each include a catalyst and a binder, and may further include a material for increasing the electrochemical surface area of the catalyst.

The first gas diffusion layers 221 and 221′, and the second gas diffusion layers 220 and 220′ may each be formed of a carbon sheet or a carbon paper, and diffuse the oxygen and the fuel supplied through the bipolar plates 120 to the entire surface of the catalyst layers 210 and 210′.

The fuel cell 100 including the MEA 110 operates at a temperature from about 100 to about 300° C., hydrogen may be supplied as a fuel to one of the catalyst layers 210 and 210′ through the bipolar plate 120, and oxygen may be supplied as an oxidizing agent to another one of the catalyst layers 210 and 210′ through the bipolar plate 120. Also, hydrogen ions (H⁺) are generated as the hydrogen is oxidized in the one of the catalyst layers 210 and 210′, the hydrogen ions (H⁺) are transmitted to the other one of the catalyst layers 210 and 210′ through the electrolyte membrane 200, and the hydrogen ions (H⁺) and oxygen electrochemically react with each other to generate water (H₂O) while generating electric energy. Here, the hydrogen supplied as a fuel may be hydrogen generated by reforming a hydrocarbon or an alcohol, and the oxygen supplied as an oxidizing agent may be supplied through air.

The embodiments of the present invention will be described in greater detail with reference to the following examples. The following examples are for illustrative purposes only and are not intended to limit the scope of the invention.

### Comparative Example A

### Preparation of Catalyst A (Pd—Cu)

A mixture of 44.526 g of 4 wt % K₂PdCl4 and 5.873 g of 4 wt % CuCl₂.2H₂O, in which an atomic ratio of Pd:Cu was 5:1, and 34.814 g of a 15 wt % EDTA aqueous solution as a chelating agent were mixed in a three-neck flask to prepare a metal precursor mixture. 10.5 g of a 1M NaOH aqueous solution was added to the metal precursor mixture, and stirred for 30 minutes to adjust pH of the metal precursor mixture to be from 10 to 11.

Meanwhile, 0.665 g of ketjen black (KB) (800 m²/g) as a carbon-based support was dispersed in 140 g of a mixture of H₂O and ethanol (the weight ratio of H₂O to ethanol was 50:50) for 30 minutes by using ultrasonic waves, so as to prepare a carbon-based support mixture.

Next, the metal precursor mixture was added to the carbon-based support mixture to prepare a first mixture.

The temperature of the first mixture was increased to 50° C., and then 28 g of 85% hydrazine was injected into the first mixture at a rate of 4 cc/min by using an aqueous solution pump, so as to reduce the Pd—Cu catalyst particle on the carbon-based support. The resultant product was filtered, washed, and dried to obtain a catalyst A, wherein 50 wt % Pd—Cu catalyst particles (an alloy of Pd and Cu, wherein the atomic ratio of Pd:Cu is 5:1) is theoretically loaded on the carbon-based support.

### Comparative Example B

### Preparation of Catalyst B (Pd—Ir)

A catalyst B, wherein a 50 wt % Pd—Ir catalyst particle (an alloy of Pd and Ir, wherein the atomic ratio of Pd:Ir is 5:1) is theoretically loaded on the carbon-based support, was obtained in the same manner as in Comparative Example A, except that a mixture of K₂PdCl₄ and H₂IrCl₆.6H₂O that is quantified in such a way that the atomic ratio of Pd:Ir becomes 5:1 was used instead of the mixture of K₂PdCl₄ and CuCl₂.2H₂O, wherein the atomic ratio of Pd:Cu is 5:1 while preparing the metal precursor mixture.

### Comparative Example C

### Preparation of Catalyst C (Pd—Cu—Ir)

A catalyst C, wherein 50 wt % Pd—Cu—Ir catalyst particles (the atomic ratio of M:Cu is 5:1, wherein M is formed of Pd and Ir, and the atomic ratio of Pd:Ir is 5:1) is theoretically loaded on the carbon-based support, was obtained in the same manner as in Comparative Example A, except that the mixture of K₂PdCl₄, CuCl₂.2H₂O, and H₂IrCl₆.6H₂O, which is quantified in such a way that the atomic ratio of M:Cu becomes 5:1, wherein M is the total amount of Pd and Ir (atomic ratio of Pd:Ir is 5:1), was used instead of the mixture of K₂PdCl₄ and CuCl₂.2H₂O, wherein the atomic ratio of Pd:Cu is 5:1 while preparing the metal precursor mixture.

### Example 1

### Preparation of Catalyst 1 (Prepared from Catalyst A)

0.7 g of the catalyst A prepared in the same manner as in Comparative Example A was added to 40 g of a mixture of H₂O and IPA (a mass ratio of H₂O to IPA is 3:1), and dispersed by using ultrasonic waves to prepare a mixture. The mixture was added to 7.237 g of a 4 wt % H₂IrCl₆.6H₂O aqueous solution (the amount of Ir is 0.008 g), and was reacted at 90° C. for 2 hours. The resulting product was filtered, washed, and dried under the same conditions as in Comparative Example A to obtain Catalyst 1.

### Example 2

### Preparation of Catalyst 2 (Prepared from Catalyst C)

0.7 g of the catalyst C prepared in the same manner as in Comparative Example C was added to 40 g of a mixture of H₂O and IPA (a mass ratio of H₂O to IPA is 3:1), and dispersed by using ultrasonic waves to prepare a mixture. The mixture was added to 1.316 g of a 1 wt % H₂IrCl₆.6H₂O aqueous solution (the amount of Ir is 0.08 g), and was reacted at 90° C. for 2 hours. The resulting product was filtered, washed, and dried under the same conditions as in Comparative Example a to Obtain Catalyst 2.

### Evaluation Example 1

### X-ray Photoelectron Spectroscopy (XPS) Analysis

XPS analysis (Micro XPS, Quantom2000, Physical Electronics/Power: 27.7 W/beam size: 100 μm/hV=1486.6 eV) was performed so as to analyze surface components of Catalyst C and Catalyst 2, and the results thereof are shown in Table 1 below.

TABLE 1

| | Cu₂ₚ | Pd_{3d} | Ir_{4f} |
|---|---|---|---|
| | (wt %) | (wt %) | (wt %) |
| Catalyst C | 6.217 | 26.127 | 7.825 |
| Catalyst 2 | 1.700 | 22.555 | 11.426 |
| (Prepared from Catalyst C) | | | |

Referring to Table 1, the amount of Cu_{2P} in the XPS data of Catalyst 2 is less than that of Catalyst C, and the amount of Ir_{4f} in the XPS data of Catalyst 2 is higher than that of Catalyst C.

### Inductively Coupled Plasma (ICP) Analysis

ICP analysis (ICP-AES, ICPS-8100, SHIMADZU/RF source 27.12 MHz/sample uptake rate 0.8 ml/min) was performed so as to analyze components of Catalysts A, C, 1, and 2, and results thereof are shown in Table 2 below.

TABLE 2

| | | Weight | | | |
|---|---|---|---|---|---|
| | | of | Weight of | Weight of | Weight of |
| | Unit | Catalyst | Cu | Pd | Ir |
| Catalyst C | wt % | 100 | 4.4 | 41.4 | 9.4 |
| (Actual Value) | g | 0.7 | 0.0308 | 0.2898 | 0.0658 |
| ¹Catalyst C′ | wt % | 100 | 4.4 | 40.9 | 10.4 |
| (Assumed Value) | g | 0.708 | 0.0308 | 0.2898 | 0.0738 |
| ²Catalyst 2 | wt % | 100 | 3.2 | 41 | 10.4 |
| (Actual Value) | g | 0.708 | 0.0226 | 0.29 | 0.0736 |
| Catalyst A | wt % | 100 | 4.86 | 45.19 | 0 |
| (Actual Value) | g | 0.7 | 0.03402 | 0.31633 | 0 |
| ³Catalyst A′ | wt % | 100 | 4.4 | 40.6 | 10.3 |
| (Assumed Value) | g | 0.78 | 0.03402 | 0.31633 | 0.08 |
| ⁴Catalyst 1 | wt % | 100 | 3.6 | 40.2 | 10.2 |
| (Actual Value) | g | 0.78 | 0.02808 | 0.31356 | 0.07956 |

¹Imaginary catalyst obtained by simply adding 0.008 g of Ir to 0.7 g of Catalyst C
²Prepared from Catalyst C
³Imaginary catalyst obtained by simply adding 0.08 g of Ir to 0.7 g of Catalyst A
⁴Prepared from Catalyst A

If Catalyst 2 prepared from Catalyst C is obtained by simply adding Ir to Catalyst C, actual values of amounts (g) of Cu, Pd, and Ir of Catalyst 2 have to be identical to assumed values of amounts (g) of Cu, Pd, and Ir of Catalyst C′. However, referring to Table 2, the amount of Cu of Catalyst 2 is smaller than the amount of Cu of Catalyst C′, the amount of Pd of Catalyst 2 is substantially identical to the amount of Pd of Catalyst C′, and the amount of Ir of Catalyst 2 is higher than the amount of Ir of Catalyst C′. Accordingly, it is determined that Catalyst 2 is obtained by substituting a part of Cu in Catalyst C with Ir.

Similarly, if Catalyst 1 prepared from Catalyst A is obtained by simply adding Ir to Catalyst A, actual values of amounts (g) of Cu, Pd, and Ir of Catalyst 1 have to be identical to assumed values of amounts (g) of Cu, Pd, and Ir of Catalyst A′. However, referring to Table 2, the amount of Cu of Catalyst 1 is smaller than the amount of Cu of Catalyst A′, the amount of Pd of Catalyst 1 is substantially identical to the amount of Pd of Catalyst A′, and the amount of Ir of Catalyst 1 is higher than the amount of Ir of Catalyst A′. Accordingly, it is determined that Catalyst 1 is obtained by substituting a part of Cu in Catalyst A with Ir.

### X-ray Diffraction (XRD) Analysis

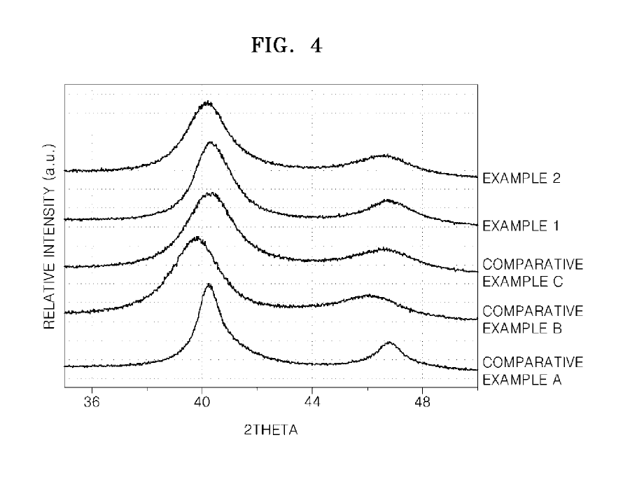

XRD analysis (MP-XRD, Xpert PRO, Philips/Power 3 kW) was performed on Catalysts A, B, C, 1, and 2, and results thereof are shown in Table 3 and FIG. 4.

TABLE 3

| | Particle Size | Diffraction Angle (2theta) |
|---|---|---|
| | (nm) | of (111) Peak |
| Catalyst A | 4.346 | 40.5553 |
| Catalyst B | 5.251 | 39.991 |
| Catalyst C | 3.908 | 40.3194 |
| Catalyst 1 | 4.945 | 40.527 |
| (Prepared from Catalyst A) | | |
| Catalyst 2 | 3.927 | 40.3177 |
| (Prepared from Catalyst C) | | |

Referring to Table 3, the difference between diffraction angles (26) of (111) peaks in the XRD patterns of Catalysts A and 1 is 0.0283, and the difference between diffraction angles (26) of (111) peaks in the XRD patterns of Catalysts C and 2 is 0.0017. Accordingly, it may be determined that the diffraction angles of the (111) peaks in the XRD patterns of Catalysts A and 1, and the diffraction angles of the (111) peaks in the XRD patterns of Catalysts C and 2 are substantially the same.

As described above, referring to Tables 1 and 2, since the amount of Cu is decreased and the amount of Ir is increased in Catalyst 1 prepared from Catalyst A, compared to Catalyst A, it may be determined that Catalyst 1 is obtained by substituting Cu in the catalyst particle of Catalyst A with Ir. Also, referring to Table 3, since the diffraction angles of the (111) peaks in the XRD patterns of Catalysts 1 and A are substantially the same, it may be determined that the lattice structures of the catalyst particle of Catalyst 1 prepared from Catalyst A, and the catalyst particle of Catalyst A are substantially the same. Accordingly, it may be determined that Catalyst 1 is obtained by substituting Cu on the surface of the catalyst particle of Catalyst A with Ir. If not only Cu on the surface of the catalyst particle of Catalyst A, but also Cu inside the catalyst particle of Catalyst A is substituted by Ir, the diffraction angle of the (111) peak in the XRD pattern of Catalyst 1 prepared from Catalyst A may be similar to the diffraction angle of Catalyst B.

Similarly, referring to Tables 1 and 2, since the amount of Cu is decreased and the amount of Ir is increased in Catalyst 2 prepared from Catalyst C, compared to Catalyst C, it may be determined that Catalyst 2 is obtained by substituting Cu in the catalyst particle of Catalyst C with Ir. Also, referring to Table 3, since the diffraction angles of the (111) peaks in the XRD patterns of Catalysts 2 and C are substantially the same, it may be determined that the lattice structures of the catalyst particle of Catalyst 2 prepared from Catalyst C, and the catalyst particle of Catalyst C are substantially the same. Accordingly, it may be determined that Catalyst 2 is obtained by substituting Cu on the surface of the catalyst particle of Catalyst C with Ir. If not only Cu on the surface of the catalyst particle of Catalyst C, but also Cu in the catalyst particle of Catalyst C is substituted by Ir, the diffraction angle of the (111) peak in the XRD pattern of Catalyst 2 prepared from Catalyst C may be similar to the diffraction angle of Catalyst B.

### Evaluation Example 2

### Preparation of Unit Cell

0.03 g of polyvinylidene fluoride (PVDF) and a suitable amount of N-methyl pyrrolidone (NMP) solvent were mixed per 1 g of Catalyst A so as to prepare a cathode slurry. The cathode slurry was coated on a carbon paper on which a microporous layer is coated, by using a bar coater, and then a cathode was prepared by drying the resulting product by gradually increasing a temperature from room temperature to 150° C. The loading amount of Catalyst A in the cathode was 1.5 mg/cm².

Separately, an anode was prepared by using a PtRu/C catalyst. The loading amount of the PtRu/C catalyst was about 0.8 mg/cm².

An MEA, A, was prepared by using 85 wt % phosphoric acid-doped t-PBOA as an electrolyte membrane disposed between the cathode and the anode.

MEAs B, C, 1, and 2 were prepared by respectively using Catalysts B, C, 1, and 2, instead of Catalyst A.

### Unit Cell Test

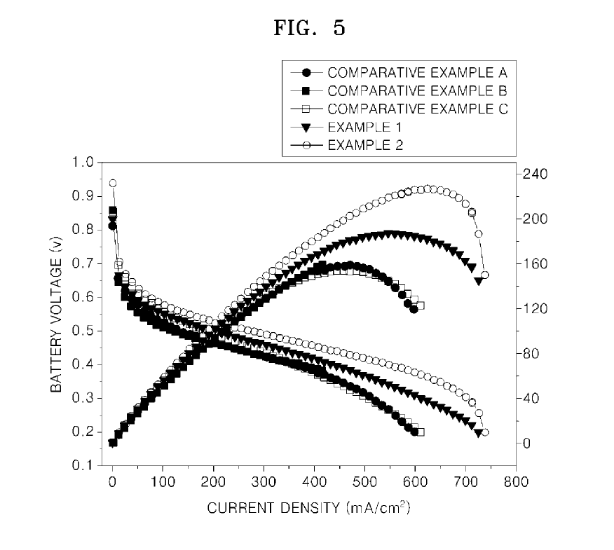

Performances of MEAs A, B, C, 1, and 2 were evaluated at 150° C. by using dry air (250 cc/min) for the cathode and dry hydrogen (100 cc/min) for the anode, and results thereof are shown in FIG. 5 and Table 4 below.

TABLE 4

| | Open Circuit Voltage | Potential (V) |
|---|---|---|
| | (OCV) (V) | @0.2 A/cm² |
| MEA A | 0.815 | 0.467 |
| (Comparative Example A) | | |
| MEA B | 0.861 | 0.465 |
| (Comparative Example B) | | |
| MEA C | 0.854 | 0.49 |
| (Comparative Example C) | | |
| MEA 1 | 0.835 | 0.51 |
| (Example 1) | | |
| MEA 2 | 0.941 | 0.545 |
| (Example 2) | | |

Referring to FIG. 5 and Table 4, it is determined that MEAs 1 and 2 have high OCVs (related to oxygen reduction reaction onset potential of a catalyst) and potentials at 0.2 A/cm2 compared to MEAs A and C. Meanwhile, the potential of MEA B at 0.2 A/cm² is lower than that of MEAs 1 and 2, and thus it is determined that performances of Catalysts 1 and 2 are excellent.

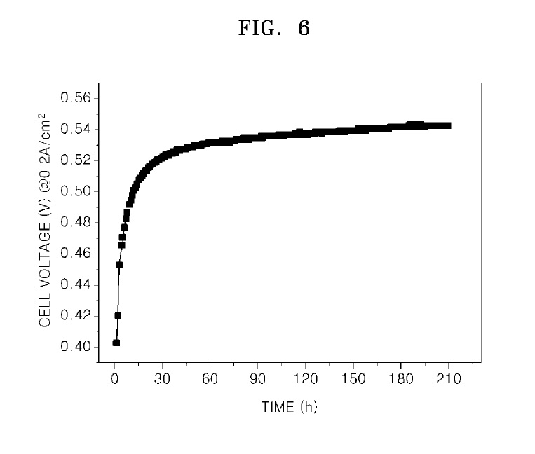

Also, the battery voltage of MEA 2 as a function of time was measured and is shown in FIG. 6. Referring to FIG. 6, it is determined that MEA 2 has excellent battery stability.

As described above, according to the one or more of the above embodiments of the present invention, the electrode catalyst for a fuel cell has excellent oxidation reduction activity and catalyst stability, and thus a high quality fuel cell can be realized at low cost, by using the electrode catalyst.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electrode catalyst for a fuel cell, the electrode catalyst comprising a catalyst particle that comprises a plurality of palladium atoms, a plurality of atoms of a transition metal, and a plurality of atoms of a precious metal having a higher standard reduction potential than the transition metal,
wherein all of the plurality of atoms of the transition metal are respectively surrounded by at least one of the palladium atoms, the neighboring atoms of the transition metal, or the atoms of the precious metal.

2. The electrode catalyst of claim 1, wherein the transition metal is at least one metal from among titanium (Ti) vanadium (V), chromium (Cr), manganese (Mn), iron (Fe), cobalt (Co), nickel (Ni), copper (Cu), and zinc (Zn).

3. The electrode catalyst of claim 1, wherein the precious metal is at least one metal from among iridium (Ir), gold (Au), platinum (Pt), rhodium (Rh), and silver (Ag).

4. The electrode catalyst of claim 1, wherein the catalyst particle has a surface that does not comprise an atom of the transition metal.

5. The electrode catalyst of claim 1, wherein the catalyst particle has an outermost atomic layer that does not comprise an atom of the transition metal.

6. The electrode catalyst of claim 1, further comprising a carbon-based support.

7. A method of preparing an electrode catalyst for a fuel cell, the method comprising:
providing a first catalyst comprising a first catalyst particle that comprises a plurality of palladium atoms and a plurality of atoms of a transition metal, wherein at least some of the plurality of atoms of the transition metal exists on a surface of the first catalyst particle; and
converting the first catalyst to the electrode catalyst of claim 1 by contacting the first catalyst to a precious metal precursor having a higher standard reduction potential than the transition metal.

8. The method of claim 7, wherein the first catalyst further comprises a carbon-based support.

9. The method of claim 7, wherein the first catalyst particle further comprises atoms of a precious metal having a higher standard reduction potential than the transition metal.

10. The method of claim 7, wherein, in the converting of the first catalyst, atoms of the transition metal existing on the surface of the first catalyst particle are substituted by atoms of the precious metal of the precious metal precursor.

11. The method of claim 7, wherein the converting of the first catalyst further comprises:
preparing a second mixture comprising the first catalyst and the precious metal precursor; and
heat-treating the second mixture.

12. The method of claim 7, wherein the amount of the precious metal in the precious metal precursor is in a range from about 0.5 parts by weight to about 20 parts by weight based on 100 parts by weight of the first catalyst.

13. The method of claim 11, wherein the second mixture further comprises at least one of a glycol-based solvent and an alcohol-based solvent.

14. The method of claim 11, wherein the second mixture is heat-treated at a temperature from about 80 to about 400° C. for a time period from about 1 hour to about 4 hours.

15. The method of claim 7, wherein, when X₁ and Y₁ respectively denote amounts of a transition metal and a precious metal in an inductively coupled plasma (ICP) measurement of the first catalyst in the amount of “A” g, and X₂ and Y₂ respectively denote amounts of the transition metal and the precious metal of an ICP measurement of the electrode catalyst in the amount of “A+B” g, X₁>X₂ and Y₁<Y₂, wherein “B” denotes the amount of the precious metal in the precious metal precursor, and conditions for the ICP analysis are a radio frequency (RF) source of 27.12 MHz and a sample uptake rate of 0.8 ml/min.

16. The method of claim 7, wherein the difference between a diffraction angle (2theta) of a (111) peak of an X-ray diffraction pattern of the first catalyst measured by Ka1 of Cu, and a diffraction angle (2theta) of a (111) peak of an X-ray diffraction pattern of the electrode catalyst measured by Ka1 of Cu is below or equal to 0.1.

17. A membrane electrode assembly for a fuel cell, the membrane electrode assembly comprising:
a cathode;
an anode disposed facing the cathode; and
an electrolyte membrane disposed between the cathode and the anode,
wherein at least one of the cathode and the anode comprises the electrode catalyst of claim 1.

18. The membrane electrode assembly of claim 17, wherein the cathode comprises the electrode catalyst.

19. A fuel cell comprising the membrane electrode assembly of claim 18.
